(19) United States
(12) Patent Application Publication
(10) Pub. No.: US 2019/0279438 A1
(43) Pub. Date: Sep. 12, 2019

(54) SYSTEMS AND METHODS FOR SERVICING A VEHICLE

(71) Applicant: Progress Rail Locomotive Inc., LaGrange, IL (US)

(72) Inventors: Scott SWENSON, Willowbrook, IL (US); Eric REMBOLDT, Rapid City, SD (US)

(73) Assignee: Progress Rail Locomotive Inc., LaGrange, IL (US)

(21) Appl. No.: 15/917,205

(22) Filed: Mar. 9, 2018

(51) Int. Cl. G07C 5/00; B61L 27/00; G07C 5/08; G06T 7/564; G06T 19/00; G06F 3/0481

(52) U.S. Cl. CPC G07C 5/008; B61L 27/0083; G07C 5/0808; G06Q 10/20; G06T 7/564; G06T 19/003; G06F 3/04815; G07C 5/0816

(57) ABSTRACT

A method for generating instructions for servicing a vehicle, the method comprising: receiving fault data related to a fault of the vehicle to a database, wherein the fault data is generated by a diagnostic system of the vehicle, and wherein the database comprises technical information of at least a portion of the vehicle and information related to one or more faults of the vehicle; sending, to a mobile device, solution data addressing the fault, wherein the solution data identifies a defective part in the vehicle; receiving an image of an object associated with the vehicle, wherein the image is captured by an image sensor on the mobile device; determining a location of the mobile device in a three-dimensional model of the vehicle based on the image; sending computer-executable programing instructions on performing an augmented reality procedure for displaying, on the mobile device, a route from the mobile device to the defective part, and instructions on servicing the defective part; after the defective part is serviced, sending a result of a diagnostic procedure to the mobile device, wherein the diagnostic procedure determines whether the fault is addressed.

### TECHNICAL FIELD

The present disclosure relates generally to systems and methods for servicing an industrial vehicle.

### BACKGROUND

When servicing a large industrial vehicle such as a locomotive, a technician often needs to spend considerable time reading schematics, system diagrams, and troubleshooting guides. Due to the size and complexity of the vehicle, it may be difficult to locate defective parts and associated components such as wires, especially when the parts and components are hidden from the general view of the vehicle. Thus, there is a need for tools that can provide real-time service instructions to a technician without comprehensive knowledge on the vehicle.

U.S. Pat. No. 9,472,028 ('028 patent) discloses an augmented-reality-based interactive troubleshooting and diagnostic systems and related operating methods. The systems and methods in the '028 patent provide a technician with instructions on the location of the part to be serviced and how to perform the service task. However, the '028 patent fails to discuss any system or method for assisting a technician to service a complex industrial vehicle without the need of obtaining knowledge of the vehicle before the service task. The systems and methods of the present disclosure may solve one or more of the problems set forth above and/or other problems in the art. The scope of the current disclosure, however, is defined by the attached claims, and not by the ability to solve any specific problem.

### SUMMARY

In one aspect, a method for generating instructions for servicing a vehicle includes receiving fault data related to a fault of the vehicle to a database, wherein the fault data is generated by a diagnostic system of the vehicle, and wherein the database comprises technical information of at least a portion of the vehicle and information related to one or more faults of the vehicle; sending, to a mobile device, solution data addressing the fault, wherein the solution data identifies a defective part in the vehicle; receiving an image of an object associated with the vehicle, wherein the image is captured by an image sensor on the mobile device; determining a location of the mobile device in a three-dimensional model of the vehicle based on the image; sending computer-executable programing instructions on performing an augmented reality procedure for displaying, on the mobile device, a route from the mobile device to the defective part, and instructions on servicing the defective part; after the defective part is serviced, sending a result of a diagnostic procedure to the mobile device, wherein the diagnostic procedure determines whether the fault is addressed.

In another aspect, a method for servicing a vehicle includes receiving an identification of a defective part of the vehicle on a mobile device; sending a query related to the defective part to a database, wherein the database comprises technical information of at least a portion of the vehicle and information related to one or more faults of the vehicle; receiving, on a mobile device, solution data comprising instructions on servicing the defective part; capturing an image of an object associated with the vehicle with an image sensor on the mobile device; determining a location of the mobile device in a three-dimensional model of the vehicle based on the image; performing an augmented reality procedure for displaying, on the mobile device, a route from the mobile device to the defective part, and the instructions on servicing the defective part; after the defective part is serviced, performing a diagnostic procedure to determine whether a fault related to the defective part is addressed; and outputting a result of the diagnostic procedure on the mobile device.

In yet another aspect, a method for servicing a locomotive, the method comprising: sending fault data related to a fault of the locomotive to a database stored on a mobile device, wherein the database comprises technical information of at least a portion of the locomotive and information related to one or more faults of the locomotive; determining, on the mobile device, solution data addressing the fault, wherein the solution data identifies a defective part in the locomotive; capturing an image of an object associated with the locomotive with an image sensor on the mobile device; determining a location of the mobile device in a three-dimensional model of the locomotive in the database based on the image; performing an augmented reality procedure for displaying, on the mobile device, a route from the mobile device to the defective part, and the instructions on servicing the defective part; after the defective part is serviced, performing a diagnostic procedure on the mobile device to determine whether the fault is addressed; and outputting a result of the diagnostic procedure on the mobile device.

### BRIEF DESCRIPTION OF THE DRAWINGS

FIG. 1 is a schematic representation of an exemplary system for servicing a vehicle.

FIG. 2 is a flow chart that illustrates an exemplary method for servicing a vehicle.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” substantially,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

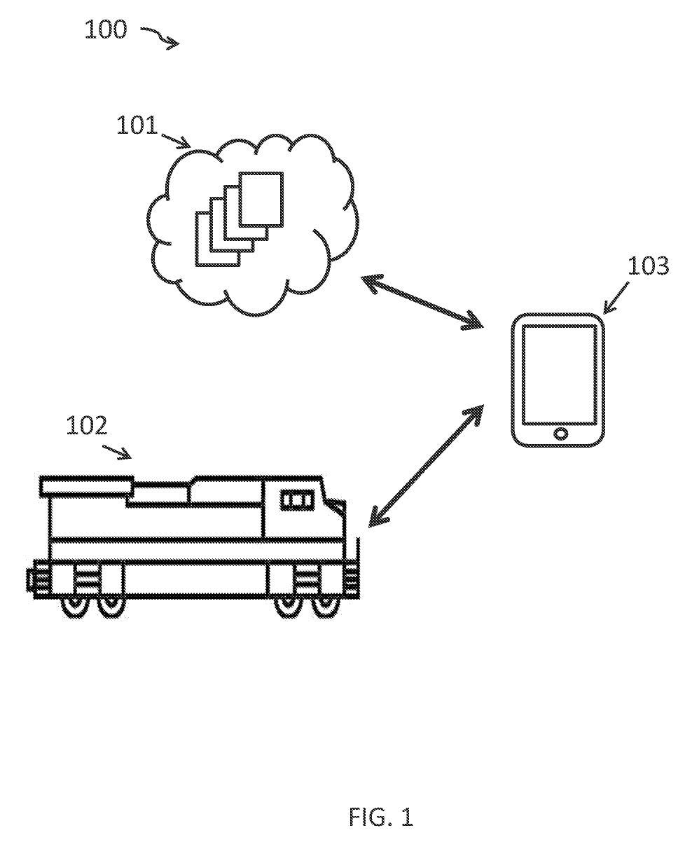

FIG. 1 illustrates an exemplary system 100 for servicing (e.g., troubleshooting, repairing, maintaining, and/or diagnosing) a vehicle 102. The exemplary system 100 may include one or more of a database 101, a vehicle 102, and a mobile device 103. In general, the mobile device 103 may receive fault data related to a fault from a diagnostic system of the vehicle 102 and communicate with the database 101 to receive solution data addressing the fault. In some cases, the fault data comprises one or more fault codes related to the fault. The mobile device 103 may assist a technician to locate and service one or more defective parts for addressing a fault using augmented reality technology (e.g., using an augmented reality application on the mobile device).

The components of system 100, e.g., database 101, vehicle 102, and mobile device 103 may include any appropriate hardware and software. For example, database 101, vehicle 102, and mobile device 103 may include one or more processors, memory, communication systems, and/or other appropriate hardware. The processors may be, for example, a single or multi-core processor, a digital signal processor, microcontroller, a general purpose central processing unit (CPU), and/or other conventional processor or processing/controlling circuit or controller. The memory may include, for example, read-only memory (ROM), random access memory (RAM), flash or other removable memory, or any other appropriate and conventional memory. The communication systems used in the components of system 100 may include, for example, any conventional wired and/or wireless communication systems such as Ethernet, BLUETOOTH, and/or wireless local area network (WLAN) type systems. Further, the communication systems may include any appropriate and conventional user interface, such as keyboards, keypads, gesture or graphical input devices, motion input devices, touchscreen interfaces, one or more displays, audio units, voice recognition units, vibratory devices, computer mice, and/or any other suitable user interface.

The software associated with the components of system 100, may include any appropriate software, programs, and/or applications for providing the functions provided in this disclosure. For example, the components of system 100 (e.g., database 101, vehicle 102, and mobile device 103) may include one or more memories or data storage devices storing instructions for performing the methods herein, a non-transitory computer readable medium for use on a computer system containing computer-executable programing instructions for performing the methods herein, and/or a processor configured to execute the instructions.

The database 101 includes information related to one or more faults of the vehicle 102. The information may include one or more fault codes of the vehicle 102. For example, the database 101 may include all fault codes related to the vehicle 102. The database may further include technical information related to the vehicle 102 or a portion thereof. Such technical information includes, but is not limited to, maintenance history, physical schematics, troubleshooting guides, maintenance instructions, catalog of parts in the vehicle, operator's manuals, engine maintenance manuals, service manuals, three-dimensional models (e.g., a low-poly model), three-dimensional models of the parts, and any combinations thereof. Information in the database, e.g., the fault codes and the technical information in the database, may be updated periodically (e.g., based on best practice). In one example, the technical information includes all publications related to the vehicle 102. The database 101 may be stored on a server, e.g., a cloud based network or system. As used herein, the term “cloud” refers to storing and accessing data and programs over the Internet. In another example, the database 101 includes instructions on how to service one or more defective parts of the vehicle 102. Alternatively or additionally, some or all of the contents (e.g., one or more of the schematics) in the database 101 may be stored in the mobile device 103. For example, the contents and function of database 101 may be entirely contained within mobile device 103, thus avoiding the need for a separate database 101.

The vehicle 102 may be an industrial vehicle. For example, the vehicle 102 may be a locomotive, a paver, a cold planer, a compactor, a dozer, a dragline, an excavator, a loader, an industrial truck, a tractor, or a reclaimer. In one example, the vehicle 102 is a locomotive. The vehicle 102 may include any appropriate sensors for determining the status of the vehicle 102. Further, vehicle 102 may include any appropriate software, processors/controllers, memory, communications systems, and/or user interfaces, as discussed above.

The mobile device 103 may be capable of communicating with the vehicle 102 and the database 101. The communications may be performed using any data communication system, such as wireless or tangible cable or connections, as discussed above. For example, the mobile device 103 may communicate with the vehicle 102 via a wireless technology, such as wireless local area network (WLAN) data communication, BLUETOOTH wireless communication, or the like. The mobile device 103 may include one or more of processors, memory, user interfaces, and software, as discussed above.

The mobile device 103 may be a mobile telephone (e.g., a smartphone), a personal digital assistant, a mobile computer device (e.g., a laptop computer, a netbook computer, a tablet computer, a near-to-eye display device, or a handheld computer), a digital media player, a portable video game device, or the like.

The mobile device 103 may comprise one or more image sensors. An image sensor may comprise one or more cameras. One or more of the cameras may be a 3D camera. In one example, the mobile device 103 includes two cameras. The mobile device 103 may further comprise a gyroscope, e.g., for determining the rotation of the mobile device 103 when the device moves with a user.

The system 100 may further comprise a data storage device storing instructions for performing the methods herein, a non-transitory computer readable medium for use on a computer system containing computer-executable programing instructions for performing the methods herein, and/or a processor configured to execute the instructions.

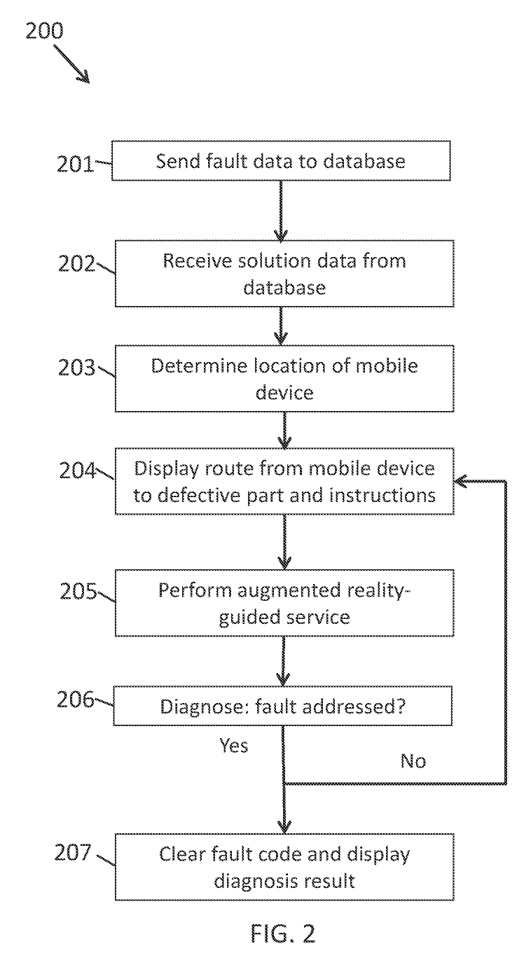

FIG. 2 is a flow chart that illustrates an exemplary method 200 for servicing a vehicle. The method may be performed by the system 100 illustrated in FIG. 1. Step 201 may include sending fault data (e.g., a fault code) related to a fault of the vehicle 102 to a database, e.g., the database 101 in the system 100. The fault data may be generated by a diagnostic system of the vehicle 102. For example, the diagnostic system may be an onboard self-diagnostic system. The diagnostic system may be triggered to generate the fault data by a technician, e.g., when the technician is inspecting the vehicle 102. Alternatively or additionally, the diagnostic system may be triggered to automatically generate fault data by a system monitoring the condition and/or fault of the vehicle 102. For example, the monitoring system may include an onboard or remote computer. The monitoring system may receive external data, including data from a sensor on or near the vehicle 102 or from a customer who has used the vehicle. In some examples, more than one fault code may be generated and/or sent to the database.

The fault data may be transmitted to the mobile device 103, which sends the fault data to the database 101. In some cases, the fault data is sent to the database 101 without the need of the mobile device 102. For example, the diagnostic system may send the fault data to the database 101 directly.

Based on the fault data, the database 101 may generate solution data addressing the fault. The solution data may include locomotive history, operational guidance, actionable work orders, inspection recommendations, servicing guidance addressing the fault, technical information related to the vehicle, and any combinations thereof In some cases, the database 101 includes a three-dimensional model (e.g., a three-dimensional computer-aided design (CAD) model) of the vehicle 102 or a portion thereof. The three-dimensional model may be a low-poly model or a lightweight three-dimensional model. For example, the three-dimensional model may be generated by a process that complies and lightweights the geometry of the vehicle 102 or a portion thereof. The three-dimensional model (e.g., the three-dimensional model of the entire vehicle 102) may be stored locally on the mobile device 103, and viewed and/or interacted with on the mobile device 103 without the need of external downloads. In some cases, the three-dimensional model may be a high-poly model. The high-poly model may be a model of a part, a wire, or any portion of the vehicle 102.

Step 202 may include receiving the solution data from the database 101. For example, the solution data may be received on the mobile device 103. The solution data may include information on one or more defective parts related to a fault. When there are more than one defective part, the solution data may also provide recommendations on the order of the defective parts that need to be inspected and/or serviced.

Alternatively or additionally, the method 200 may include receiving an identification of one or more defective parts of the vehicle 102 on the mobile device 103. The identification may be entered by a user of the mobile device 103, by a diagnostic system of the vehicle 102, or a system monitoring the vehicle 102. In some cases, the method further comprises sending a query related to the defective part(s) to the database 101. Sending of the query may be triggered by the user, the diagnostic system, or the system monitoring the vehicle 102.

Step 203 may include determining the location of the mobile device 103. The location of the mobile device 103 may indicate the location of the technician using the mobile device 103. For example, when using the mobile device 103, the technician may hold or wear the mobile device 103. The location of the mobile device 103 may be a relative location in the three-dimensional model of the vehicle 102. To determine the location of the mobile device 103, one or more images of an object in the vehicle 102 may be captured by an image sensor, e.g., an image sensor on the mobile device 103. The object may include any portion of the vehicle 102, such as one or more parts of the vehicle 102. In some examples, the image sensor includes two cameras for capturing images of the object. In some cases, the images are captured using simultaneous localization and mapping technology (SLAM). The image sensor may constantly scan the objects in the vehicle for monitoring the location of the mobile device 103.

The image(s) of the object may be analyzed to determine one or more features of the object. The feature(s) may include the size (e.g., width and height), contours, and the number of contrasted areas of the object. The determined feature(s) may be used to search in the database 101 for identifying the object. Once the object is identified, the relative location of the object in the three-dimensional model of the vehicle is determined and displayed on the mobile device 103. In some cases, one or more images of a unique part or a set of parts near the mobile device 103 are captured and analyzed. The features of the unique part, or the pattern and/or distance among the set of parts may be searched in the database 101 to determine the relative location of the unique part or the set of parts in the vehicle 102. In the cases where the parts in the captured images are on different vehicle models, the user may confirm that the searched database corresponds to the correct model of vehicle being serviced.

Step 204 may include displaying a route from the mobile device 103 to a defective part that needs to be serviced. The route may be a graphic overlay with an indicator (e.g., a highlighted line) showing for a technician how to move to a destination for servicing the defective part (e.g., by displaying each next step). The route displayed may also show one or more obstacles that need to be removed. In some examples, the determination of the location of the mobile device 103 and/or the route from the mobile device to the defective part does not require a global position system (GPS).

Step 204 may further include displaying step-by-step instructions for moving to the destination. The step-by-step instructions may guide the technician to remove one or more obstacles before getting to the destination. Examples of the obstacles include panels, doors, and covers. The step-by-step instructions may also recommend tools for removing the obstacles. Alternatively or additionally, the step-by-step instructions may include guidance on bypassing the obstacles, e.g., recommendations on changing elevation using walkways, ladders, and stairs on the vehicle 102.

Step 204 may further include displaying step-by-step instructions for inspecting, repairing, and/or replacing the defective part. For example, the step-by-step instructions may include the information on the parts and the associated components (e.g., connecting wires) that the technician needs to inspect, repair, and/or replace, and the actions the technician needs to take.

Step 205 may include performing the service with the guide of augmented reality technology. The route and/or instructions in Step 204 may be displayed using augmented reality technology. The augmented reality technology allows the technician to quickly and precisely locate the defective part and to understand the actions needed to complete the service task. For example, the augmented realty technology may walk the technician through the steps need to take in a service. With the augmented reality technology, the technician dose not need to obtain comprehensive, or any, knowledge about the vehicle 102 before performing the service. In some cases, the augmented technology is interactive, allowing the technician to search for more information, ask specific questions, and/or review job history and status. The service may be assisted by an augmented reality application with executable instructions stored on the mobile device 103.

Step 206 may include performing a diagnostic procedure on the vehicle 102 after the service task in Step 205. The result of the diagnostic procedure may be output on the mobile device 103. The diagnostic procedure may be performed on the mobile device. Alternatively or additionally, the diagnostic procedure may be performed by a device or system separate from the mobile device. In such cases, the result of the diagnostic procedure may be sent to the mobile device. The result may indicate whether the fault is completely addressed. If the fault is completely addressed, related fault code(s) may be cleared and a notification may be displayed on the mobile device 103 indicating the service is completed (Step 207). A notification may also be sent to the system that monitors the condition of the vehicle 102. If the fault is not completely addressed after Step 205, further instructions may be displayed on the mobile device 103 to indicate the next step. Such next step may include servicing a second defective part. In these cases, Steps 204 to 206 may be repeated for servicing the second defective part until the diagnosis result shows that the fault is completely addressed.

The present disclosure may also include methods for generating instructions for servicing a vehicle. The instructions may be a computer-executable programming instructions to the mobile device 103 for performing one or more steps of vehicle servicing methods disclosed herein. In some examples, the instructions may be generated from a server, e.g., a cloud-based server.

### INDUSTRIAL APPLICABILITY

The present disclosure finds potential application in servicing any industrial vehicles. The present disclosure enables a technician to service an industrial vehicle without the need of obtaining information on the vehicle before the service task.

For example, the present disclosure includes a method for troubleshooting a defective wire on a locomotive. In such an example, the schematics of the locomotive in a cloud-based database are accessible by a mobile device using an augmented reality application so that the technician performing the troubleshooting does not need to read the schematics before the task. A fault code is sent to the cloud-based database, which then sends solution data including the wires to be inspected to the mobile device. A mobile device with two cameras is pointed to an object in the locomotive. Identification of the object captured and the location of the mobile device in the locomotive are determined by searching the features of the object in a database. An augmented reality application on the mobile device overlays the wires that need to be inspected.

The technician, with the assistance of the solution data, highlights one of the wires on the augmented reality application. Once highlighted, the entire wire (including the portion hidden from the general view) and the termination point of the wire are highlighted on the mobile device. A route from the mobile device to remote portions of the wire is displayed on the mobile device. Step-by-step instructions are displayed by the augmented reality application on the mobile device. The instructions include guidance for inspecting the continuity and the power in the highlighted wire. The instructions also provide expected ranges of values for the technician to determine whether the highlighted wire is defective. When a defective wire is identified by the technician, the augmented reality application displays instructions for repairing or replacing the defective wire. Once the wire is repaired or replaced, a diagnostic procedure can be performed and the result of the diagnostic procedure displayed indicating the defect is cleared.

It will be apparent to those skilled in the art that various modifications and variations can be made to the disclosed system without departing from the scope of the disclosure. Other embodiments of the system will be apparent to those skilled in the art from consideration of the specification and practice of the rotor deployment mechanism disclosed herein. It is intended that the specification and examples be considered as exemplary only, with a true scope of the disclosure being indicated by the following claims and their equivalents.

1. A method for generating instructions for servicing a vehicle, the method comprising:
receiving fault data related to a fault of the vehicle to a database, wherein the fault data is generated by a diagnostic system of the vehicle, and wherein the database comprises technical information of at least a portion of the vehicle and information related to one or more faults of the vehicle;
sending, to a mobile device, solution data addressing the fault, wherein the solution data identifies a defective part in the vehicle;
receiving an image of an object associated with the vehicle, wherein the image is captured by an image sensor on the mobile device;
determining a location of the mobile device in a three-dimensional model of the vehicle based on the image;
sending computer-executable programing instructions on performing an augmented reality procedure for displaying, on the mobile device, a route from the mobile device to the defective part, and instructions on servicing the defective part;
after the defective part is serviced, sending a result of a diagnostic procedure to the mobile device, wherein the diagnostic procedure determines whether the fault is addressed.

2. The method of claim 1, wherein the image is captured by two cameras included in the image sensor.

3. The method of claim 1, further comprising detecting a rotation of the mobile device using a gyroscope.

4. The method of claim 1, further comprising determining the route from the mobile device to the defective part using simultaneous localization and mapping technology.

5. The method of claim 1, wherein determining a location of the mobile device comprises identifying the object by determining one or more features of the object based on the image and searching the one or more features of the object in the database.

6. The method of claim 1, wherein the object comprises one or more parts of the vehicle.

7. The method of claim 1, wherein the three-dimensional model of the vehicle comprises a three-dimensional model of only a portion of the vehicle.

8. The method of claim 1, wherein the defective part is a first defective part, and the result of the diagnostic procedure comprises a route from the mobile device to a second defective part and instructions on servicing the second defective part.

9. The method of claim 1, wherein the result of the diagnostic procedure comprises an indication that the fault has been addressed.

10. The method of claim 1, wherein the three-dimensional model of the vehicle is a low-poly model.

11. The method of claim 1, wherein the instructions on servicing the defective part include instructions for overcoming or removing an obstacle on the route.

12. The method of claim 1, further comprising verifying a model of the vehicle.

13. The method of claim 1, wherein the technical information comprises schematics, parts catalogs, maintenance manuals, or a combination thereof.

14. The method of claim 1, wherein the vehicle is a locomotive.

15. The method of claim 1, wherein the solution data comprises the instructions on servicing the defective part.

16. A method for servicing a vehicle, the method comprising:
receiving an identification of a defective part of the vehicle on a mobile device;
sending a query related to the defective part to a database, wherein the database comprises technical information of at least a portion of the vehicle and information related to one or more faults of the vehicle;
receiving, on a mobile device, solution data comprising instructions on servicing the defective part;
capturing an image of an object associated with the vehicle with an image sensor on the mobile device;
determining a location of the mobile device in a three-dimensional model of the vehicle based on the image;
performing an augmented reality procedure for displaying, on the mobile device,
a route from the mobile device to the defective part, and
the instructions on servicing the defective part;
after the defective part is serviced, performing a diagnostic procedure to determine whether a fault related to the defective part is addressed; and
outputting a result of the diagnostic procedure on the mobile device.

17. The method of claim 16, wherein the identification of a defective part of the vehicle is received from a user of the mobile device.

18. The method of claim 16, wherein the identification of a defective part of the vehicle is received from a monitoring system of the vehicle.

19. The method of claim 16, wherein the vehicle is a locomotive.

20. A method for servicing a locomotive, the method comprising:
sending fault data related to a fault of the locomotive to a database stored on a mobile device, wherein the database comprises technical information of at least a portion of the locomotive and information related to one or more faults of the locomotive;
determining, on the mobile device, solution data addressing the fault, wherein the solution data identifies a defective part in the locomotive;
capturing an image of an object associated with the locomotive with an image sensor on the mobile device;
determining a location of the mobile device in a three-dimensional model of the locomotive in the database based on the image;
performing an augmented reality procedure for displaying, on the mobile device,
a route from the mobile device to the defective part, and
the instructions on servicing the defective part;
after the defective part is serviced, performing a diagnostic procedure on the mobile device to determine whether the fault is addressed; and
outputting a result of the diagnostic procedure on the mobile device.

21-35. (canceled)
